(19) United States
(12) Patent Application Publication
(10) Pub. No.: US 2023/0169072 A1
(43) Pub. Date: Jun. 1, 2023

(54) AUGMENTED QUERY VALIDATION AND REALIZATION

(71) Applicant: SAP SE, Walldorf (DE)

(72) Inventor: Malavikha A, Bangalore (IN)

(73) Assignee: SAP SE, Walldorf (DE)

(21) Appl. No.: 17/538,396

(22) Filed: Nov. 30, 2021

(51) Int. Cl. G06F 16/242; G06F 40/247; G06N 20/00

(52) U.S. Cl. CPC G06F 16/2428; G06F 16/2423; G06F 16/2445; G06F 40/247; G06N 20/00

(57) ABSTRACT

Technologies are described for mapping data elements for pre-built analytics dashboards. For example, a list of data elements that are present in a target landscape can be obtained and compared to data elements that are used by a pre-built analytics dashboard to determine a first category of data elements that are present in the target landscape but not in the pre-built analytics dashboard and a second category of data elements that are present in the pre-built analytics dashboard but not in the target landscape. The data elements that are present in the pre-built analytics dashboard but not in the target landscape can then be mapped to the data elements in the target landscape using a trained machine learning model. The trained machine learning model uses word pockets to separately associate data elements with standard terminology and synonyms.

### BACKGROUND

The concept of self-service analytics has gained popularity in recent years. Self-service analytics allow a user to analyze an organization's data without having to build a custom analytics report. For example, the user could obtain a pre-built dashboard, connect it to the organization's data, and begin using the visualizations provided by the dashboard.

While self-service analytics solutions can be useful and efficient, they suffer from a number of issues. Self-service analytics solutions are heavily dependent on the terminology used by the dashboard and the terminology used by the customer landscape. When there is a mismatch between the two, the dashboard may not operate correctly. For example, self-service analytics solutions are often built using standard terminology, such as standard database field names. If the standard terminology used by the self-service analytics solutions does not match that used by the organization, then the solutions will not operate correctly or at all.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for mapping data elements for pre-built analytics dashboards. For example, the technologies can comprise obtaining a list of data elements that are present in a target landscape, comparing the list of data elements that are present in the target landscape to data elements used by a pre-built analytics dashboard, and based on the comparing, determining a first category of data elements that are present in the target landscape but not in the pre-built analytics dashboard, and a second category of data elements that are present in the pre-built analytics dashboard but not in the target landscape. The technologies can further comprise, for each of one or more of the data elements that are present in the pre-built analytics dashboard but not in the target landscape, mapping the data element to one of the data elements in the target landscape using, at least in part, a trained machine learning model, where the trained machine learning model uses word pockets to separately associate data elements with standard terminology and synonyms.

Other technologies for mapping data elements for pre-built analytics dashboards can comprise obtaining a list of data elements used in a target landscape and comparing the list to data elements used by a pre-built analytics dashboard. Based on the comparison, three categories can be determined, a first category of data elements that are present in the target landscape but not in the pre-built analytics dashboard, a second category of data elements that are present in the pre-built analytics dashboard but not in the target landscape, and a third category of data elements that match between the pre-built analytics dashboard and the target landscape. The data elements in the second category can then be mapped to the data elements in the first category using a trained machine learning model, where the trained machine learning model uses word pockets to associate data elements with standard terminology and synonyms. The pre-built analytics dashboard can then be executed using, at least in part, the mapped data elements in the first category and the data elements in the third category.

Other technologies for training machine learning models for mapping data elements for pre-built analytics dashboards can comprise receiving, for each of a plurality of data elements that are used by a pre-built analytics dashboard, a first set of data element names representing standard terminology used to refer to the data element and a second set of data element names representing synonyms used to refer to the data element. A machine learning model can be trained by creating a representation of a word pocket for each of the plurality of data elements that are used by the pre-built analytics dashboard, where the word pocket associates the data element with the first set of data element names representing standard terminology and the second set of data element names representing synonyms. The trained machine learning model can then be output.

### BRIEF DESCRIPTION OF THE DRAWINGS

FIG. 1 is a diagram depicting example word pockets, including standard terminology and synonyms.

FIG. 2 is a flowchart of an example process for training machine learning models to map data elements used in pre-built analytics dashboards.

FIG. 3 is a flowchart of an example process for mapping data elements for pre-built analytics dashboards.

FIG. 4 is a flowchart of an example process for mapping data elements for pre-built analytics dashboards using a trained machine learning model that uses word pockets.

FIG. 5 is a flowchart of an example process for training a machine learning model using word pockets.

FIG. 6 is a diagram of an example computing system in which some described embodiments can be implemented.

FIG. 7 is an example cloud computing environment that can be used in conjunction with the technologies described herein.

### DETAILED DESCRIPTION

Overview

The following description is directed to technologies for mapping data elements for pre-built analytics dashboards. For example, a list of data elements that are present in a target landscape can be obtained and compared to data elements that are used by a pre-built analytics dashboard to determine a first category of data elements that are present in the target landscape but not in the pre-built analytics dashboard and a second category of data elements that are present in the pre-built analytics dashboard but not in the target landscape. The data elements that are present in the pre-built analytics dashboard but not in the target landscape (the second category) can then be mapped to the data elements in the target landscape (the first category) using a trained machine learning model. The trained machine learning model uses word pockets to separately associate data elements with standard terminology and synonyms.

The goal of self-service analytics solutions is to provide pre-built solutions that the user can obtain and run within the user's environment. However, it is often the case that the user will experience problems with trying to run a pre-built solution. The most common problem is that the pre-built solution uses different data elements than those present in the user's environment. For example, the pre-built solution may use data elements with different names. As a result, the user needs to spend a significant amount of time to manually modify and/or map the pre-built solution (e.g., to map the data elements used by the database queries of a pre-built solution) so that it works within the user's environment. Even with such manual mapping, the user may not be able to determine which data elements used by the pre-built solution match existing data elements in the user's environment.

The technologies provided herein for automatically mapping data elements for pre-built analytics dashboards using trained machine learning models, and for training such machine learning models, provide advantages over previous manual mapping solutions. For example, mapping of data elements used by pre-built analytics dashboards can be automatically performed using trained machine learning models and the mapped data elements can then be used when executing the pre-built analytics dashboards without having manually map the data elements. This reduces the effort (e.g., the total cost of ownership (TCO)) of implementing and maintaining pre-built analytics dashboards. It also reduces or eliminates the steps of rebuilding and remapping work that would otherwise need to be carried out by report designers or consultants at the organization's (e.g., customer's) end to make the pre-built analytics dashboards work. Furthermore, the end user is not frustrated with error messages when a pre-built analytics dashboard does not operate correctly (e.g., the end user does not have to contact support personnel for the pre-built analytics dashboard).

### Terminology

The term “pre-built analytics content” refers to an analytics report or dashboard that has been modeled in advance and is therefore ready for use (e.g., by a business user). For example, pre-built analytics content can include visualization and/or key performance indicator (KPI) tiles that are already defined and modeled so that the user can connect to a data source and start visualizing the data in the form of meaningful charts, graphs, or other visualization elements. Pre-built analytics content is also referred to as plug-and-play analytics or pre-built analytics dashboards.

The term “landscape” refers to the names of the data elements (dimensions, measures, fields, and/or other data elements) that are used when defining or using pre-built analytics content. Data elements can refer to specific database fields (e.g., an employee ID field in a database table), dimensions (e.g., a region dimension that groups employees by state or country), measures (a sum, average, or other function performed on data, such as a sum of employees in a region), or other types of data elements.

The term “source landscape” refers to the landscape that is used to model the pre-built analytics content. In other words, the source landscape is the landscape used by the provider of the pre-built analytics content. The source landscape uses standard (e.g., industry standard, line-of-business standard, or otherwise common) names for the data elements.

The term “target landscape” refers to the landscape of the organization within which the pre-built analytics dashboard is being used. The target landscape of a specific organization includes the specific names of the data elements (e.g., dimensions, measures, fields, etc.) of the specific organization. When a pre-built analytics dashboard is obtained by the specific organization, the source landscape used by the pre-built analytics dashboard may not match the target landscape used by the specific organization. For example, the source landscape may use “employee ID” to identify specific employees in a specific dashboard, while the target landscape may use a different term to identify specific employees, such as “user ID” or “employee code.”

Example Automated Query Validation

In the technologies described herein, automated query validation can be performed to determine the differences between a source landscape and a target landscape for pre-built analytics content. Specifically, when implementing pre-built analytics content, various queries will need to be executed to obtain data (e.g., from a database). Query validation refers to the process of determining which data elements are needed by the queries (i.e., that are needed in order to implement the pre-built analytics content) that cannot be directly mapped (e.g., by identifying data elements with the same name) in the target landscape. Automated query validation can be performed as a first phase of customizing pre-built analytics content for a given organization.

In some implementations, automated query validation is performed by obtaining a source landscape comprising data element names used in a pre-built analytics dashboard and a target landscape comprising data element names used by an organization. The source landscape and the target landscape are then compared to determine data elements that are present in the source landscape but not in the target landscape, and data elements that are present in the target landscape but not the source landscape. The results can then be used when mapping data elements in the source landscape that do not have a direct match based on the comparison.

As a simplified example, the source landscape could have a data element named “employee ID” which is not present in the target landscape (i.e., the target landscape does not have a data element named “employee ID”), while the target landscape could have a data element named “employee code” which is not present in the source landscape. Mapping can then be performed using a trained machine learning model to determine whether the “employee ID” data element should be mapped to the “employee code” data element.

In some implementations, automated query validation is performed by obtaining a source landscape indicating the data elements that are used in a pre-built analytics dashboard and a target landscape indicating the data elements that are used by an organization. The source landscape and the target landscape are then compared to determine three categories of data elements. The first category indicates the data elements that match between the source landscape and the target landscape (e.g., the source landscape could have data elements “first name” and “last name,” which matches data elements “first name” and last name” in the target landscape). The second category indicates the data elements that are present in the source landscape but not in the target landscape (e.g., the source landscape could have a data element named “employee ID,” and there is no “employee ID” data element present in the target landscape), also referred to as the surplus source elements. The third category indicates the data elements that are present in the target landscape but not in the source landscape, also referred to as the surplus target elements.

In general, there can be a number of data elements that are present in the source landscape but that cannot be directly mapped in the target landscape because the target landscape uses different data element names. However, it is also possible that any given data element in the source landscape does not have a match in the target landscape even under a different name (e.g., the target landscape may not store the type of data referred to be the data element). It is also possible that there are data elements in the target landscape that do not have a match, even under a different name, in the source landscape (e.g., the target landscape may have additional data elements that are not used by a specific pre-built analytics dashboard being analyzed).

Example Augmented Query Realization

In the technologies described herein, augmented query realization can be performed to map the remaining data elements from the source landscape (that could not be directly matched in the automated query validation phase) to data elements present in the target landscape. Augmented query realization can be performed as a second phase of customizing pre-built analytics content for a given organization. Once the mapping has been performed, pre-built analytics dashboards can be executing using the mapped data elements.

The augmented query realization phase uses trained machine learning models when performing the mapping. The trained machine learning models are trained to map data elements using word pockets. For example, a trained machine learning model can receive a source data element as input, identify a set of potential data elements that the source data element could map to (e.g., standard terminology and synonyms), and map the source data element to a target element based on the potential data elements (e.g., prioritizing matches within the standard terminology over matches within the synonyms).

The augmented query realization phase uses the concept of word pockets to perform the mapping. A word pocket for a given data element defines a relationship between the given data element (which is a data element used in a pre-built analytics dashboard) and various other names by which the given data element might be known. Specifically, there are two types or categories of other names that a given data element can be associated with. The first type lists standard terminology for the given data element. Standard terminology can be derived from terminology used in the same (or similar) line of business and/or the same (or similar) industry as the pre-built analytics content. For example, in a human resources (HR) line of business, a standard term for “job posting owner” might be “hiring manager.” The second type lists synonyms used by an organization (e.g., by a customer). Synonyms are non-standard terms (not standard to an industry or line of business) used by one or more specific organizations to refer to data elements. Such synonyms are also referred to as organization defined synonyms or organization specific synonyms. For example, a specific organization may use the term “recruiter” to refer to a “job posting owner.”

Table 1 below lists example data elements and their associated standard terminology and synonyms that can be used when generating word pockets.

TABLE 1
Example data elements

| Data element name | Standard terminology | Synonyms |
|---|---|---|
| Job Posting Owner | Owner | Employee |
| | Business Partner | Recruiter |
| | Hiring Manager | HR Business Partner |
| Cost Center | Expense LoB | Field Costs |
| P&L Total | Profit and Loss | Income Statement |
| | Statement | |
| Region | Location | Responsibility Center |
| | | Zone |
| | | Area |
| # Accepted Interviews | Number of Interviews | <unchanged> |

In Table 1, the designation “<unchanged>” means that there are no synonyms for this data element (or no synonyms that are likely to be used), and that the standard terminology (in this example” number of interviews”) would likely be used in both the source and target landscapes.

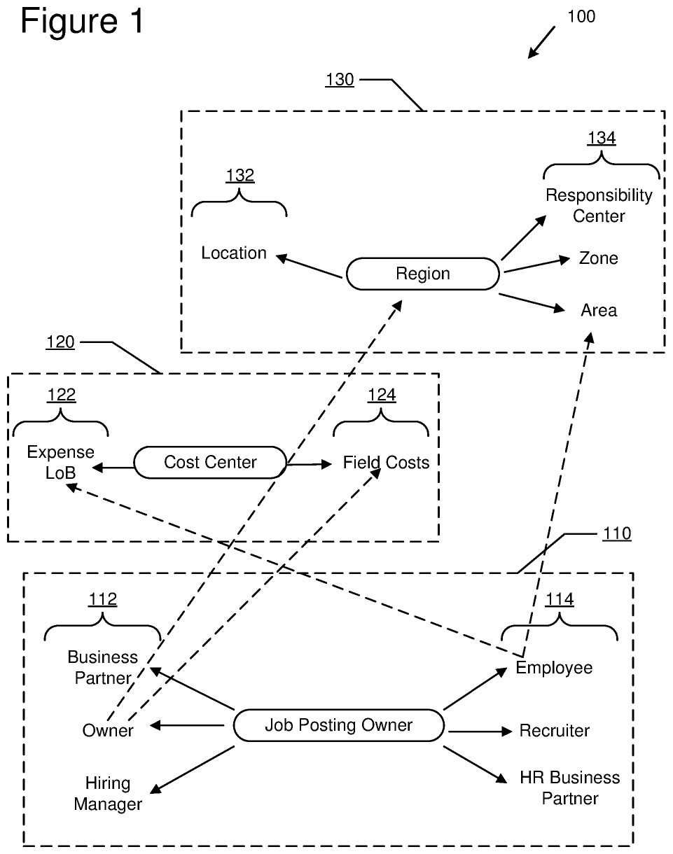

FIG. 1 is a diagram depicting example word pockets 100 (also referred to as a word pocket space). The example word pockets 100 are generated when training a machine learning model (in this example, the machine learning model has been trained to map data elements for pre-built analytics dashboards in the HR space). The trained machine learning model then uses the example word pockets 100 when performing the mapping.

As depicted in FIG. 1, there are three example word pockets depicted, word pocket 110, word pocket 120, and word pocket 130. Word pocket 110 has been generated for the data element “job posting owner,” and depicts standard terminology 112 and synonyms 114 for the data element “job posting owner.” For example, if a machine learning model that stores the example word pocket 110 is queried to return all of the possible alternative terminology for the data element “job posting owner,” the machine learning model would return “business partner,” “owner,” and “hiring manager” as standard terminology (as depicted at 112) and “employee,” “recruiter,” and “HR business partner” as synonyms (as depicted at 114). Word pocket 120 has been generated for the data element “cost center,” and depicts standard terminology 122 and synonyms 124. Word pocket 130 has been generated for the data element “region,” and depicts standard terminology 132 and synonyms 134

A trained model that represents the example word pockets 100 can be used when mapping data elements for pre-built analytics dashboards to data elements used by a specific organization. A first example pre-built analytics dashboard could present (e.g., in a graphical user interface view) the number of job requisitions that have been posting by a give job posting owner. Data elements for the first example dashboard can be evaluated based on just word pocket 110 (i.e., without having to consider word pockets 120 or 130). However, in some situations, multiple word pockets, and the relationships between them, may need to be considered. For example, a second example pre-built analytics dashboard could present how many job posting owners have posted requisitions in various regions (e.g., in the U.S., Europe, etc.). Data elements for the second example dashboard may need to be evaluated based on both word pocket 110 and word pocket 130, utilizing the relationship between an “owner” in word pocket 110 and a “region” in word pocket 130.

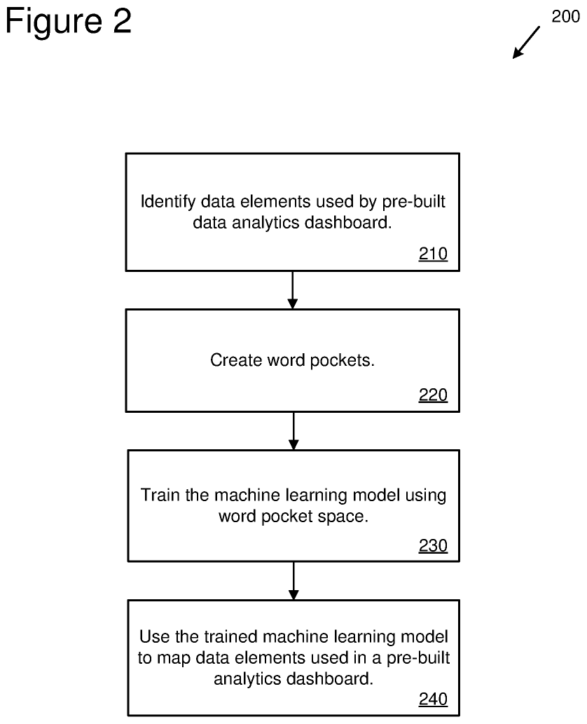

FIG. 2 is a flowchart of an example process 200 for training machine learning models to map data elements used in pre-built analytics dashboards. Specifically, machine learning models are trained to recognize data elements (e.g., the surplus source data elements that are present in the source landscape but not in the target landscape) and to map those data elements using word pockets.

At 210, data elements (e.g., measures, dimensions, and/or other types of data elements) used by a pre-built analytics dashboard are identified. The pre-built analytics dashboard can be line-of-business and/or industry specific dashboards. The data elements are identified from query definitions used in the dashboard.

At 220, word pockets are created (defining a word pocket space) for the data elements identified at 210. Each word pocket is associated with a specific data element and has associated lists of standard terminology and synonyms. The concept of word pocket space is built on the concept that every data element belongs to a type-based word class label, and each class exists as a separate word pocket.

At 230, a machine learning model (e.g., a predictive conversional model) is trained using the word pocket space. The machine learning model allows one data element to be associated with many meanings (standard terminology and synonyms). In some implementations, polysemy is reduced or eliminated (e.g., using stochastic gradient descent) for each data element in order to compartmentalize each data element. Polysemy is reduced by deriving the context from each region in the word pocket space. Each data element is segregated as a result set of the standard terminology and synonyms where the frequency of occurrence of the data element within each search input is used to calculate its associated weight. Context can also be derived by skimming adjacent search inputs into a single input unit associated with each data element.

At 240, the trained machine learning model is used to map data elements used in pre-built analytics dashboards to data elements used by a specific organization. For example, the trained machine learning model can be used to map data elements of an input query (e.g., in the form of a business question) to an organization specific version of the query that is then used when executing a pre-built analytics dashboard. For example, using the trained machine learning mode, various business questions (e.g., incorporated in pre-built analytics dashboards) can be mapped. Some example business questions are: what are the total interview numbers by employee, how many interviews are being taken each month, how many employees have accepted interviews, and what is the breakdown of interviews by job position and region?

Methods for Mapping Data Elements for Pre-Built Analytics Dashboards

In the technologies described herein, methods can be provided for mapping data elements for pre-built analytics dashboards. The mapping is performed, at least in part, using trained machine learning models that use word pockets to associate data elements with standard terminology and synonyms. Machine learning models can also be trained to perform the mapping using word pockets.

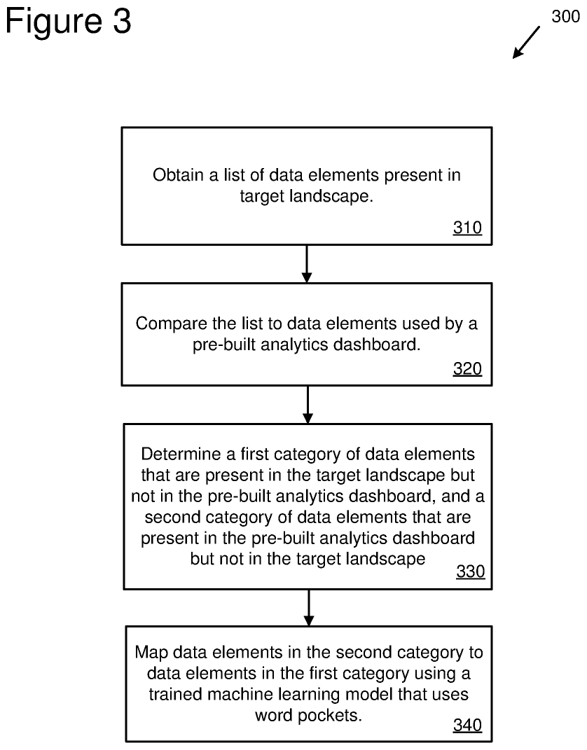

FIG. 3 is a flowchart of an example process 300 for mapping data elements for pre-built analytics dashboards. For example, the example process 300 can be performed by software running on computing resources (e.g., a computing device such as a laptop, desktop, or server, or cloud computing resources).

At 310, a list of data elements present in a target landscape is obtained. At 320, the list of data element present in the target landscape is compared to data elements that are present in a pre-built analytics dashboard.

At 330, at least wo categories of data elements are determined based on the comparison performed at 320. The first category of data elements is those that are present in the target landscape but not present in the pre-built analytics dashboard. The second category of data elements is those that are present in the pre-built analytics dashboard but not in the target landscape. In some implementations, the first and second categories are determined by matching data element names. An example of a matching data element name is the data element “pay grade” that is present in both the target landscape and the pre-built analytics dashboard. In this case, the “pay grade” data element would not be included in either category. However, if the target landscape includes the data element “pay scale” (which is not in the pre-built analytics dashboard), then the first category would include the “pay scale” data element. Similarly, if the pre-built analytics dashboard includes the data element “pay grade” (which is not in the target landscape), then the second category would include the “pay grade” date element. In some implementations, a third category is also determined, which contains those data elements that directly match (e.g., based on data element name) between the target landscape and the pre-built analytics dashboard.

At 340, the data elements in the second category are mapped to the data elements in the first category using, at least in part, a trained machine learning model. The trained machine learning model uses word pockets to separately associate data elements with standard terminology and synonyms. In some implementations, the mapping is performed for each of one or more of the data elements (e.g., for each of the data elements) present in the pre-built analytics dashboard but not in the target landscape. In other words, the trained machine learning model is used to map those data elements used by the pre-built analytics dashboard that could not be directly mapped (e.g., by name comparison) at 330.

Results of the mapping performed at 340 can be output. For example, indications of which data elements have been mapped (associated with each other) can be saved or displayed (e.g., to a user). The mapped data elements can be used when executing the pre-built analytics dashboard. For example, associations between the mapped data elements can be saved and used when the pre-built analytics dashboard is executed. In some implementations, results can include indications of data elements that could not be matched or mapped (e.g., so that a user can manually review, and possibly manually map, those data elements).

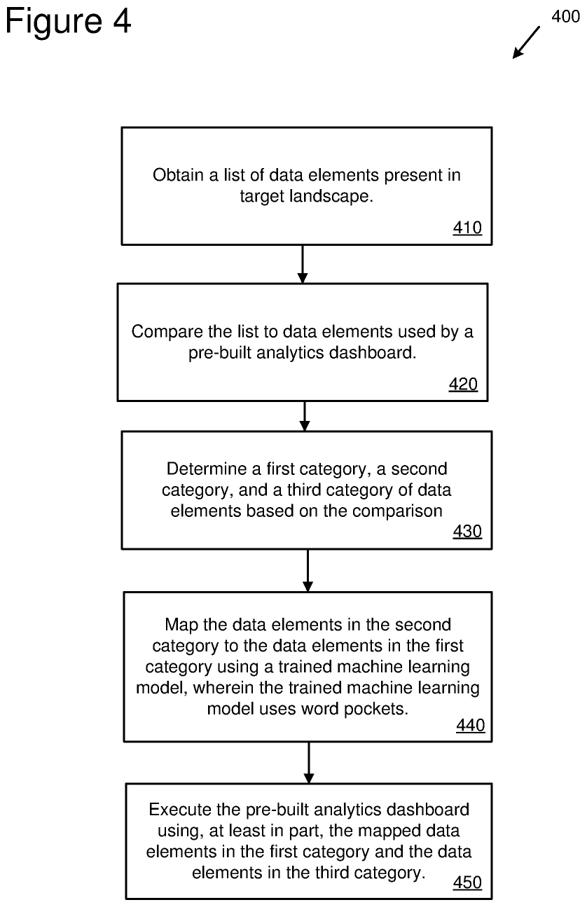

FIG. 4 is a flowchart of an example process 400 for mapping data elements for pre-built analytics dashboards using a machine learning model that uses word pockets. For example, the example process 400 can be performed by software running on computing resources (e.g., a computing device such as a laptop, desktop, or server, or cloud computing resources).

At 410, a list of data elements present in a target landscape is obtained. At 420, the list of data element present in the target landscape is compared to data elements that are present in a pre-built analytics dashboard.

At 430, three categories of data elements are determined based on the comparison performed at 420. The first category of data elements is those that are present in the target landscape but not present in the pre-built analytics dashboard. The second category of data elements is those that are present in the pre-built analytics dashboard but not in the target landscape. The third category of data elements is those that match between the target landscape and the pre-built analytics dashboard. In some implementations, the three categories are determined by matching data element names. An example of a matching data element name is the data element “pay grade” that is present in both the target landscape and the pre-built analytics dashboard. In this case, the “pay grade” data element would be included in the third category. As another example, if the target landscape includes the data element “pay scale” (which is not in the pre-built analytics dashboard), then the first category would include the “pay scale” data element. Similarly, if the pre-built analytics dashboard includes the data element “pay grade” (which is not in the target landscape), then the second category would include the “pay grade” date element.

At 440, the data elements in the second category are mapped to the data elements in the first category using, at least in part, a trained machine learning model. The trained machine learning model uses word pockets to separately associate data elements with standard terminology and synonyms. In some implementations, the mapping is performed for each of one or more of the data elements (e.g., for each of the data elements) present in the second category. In other words, the trained machine learning model is used to map those data elements used by the pre-built analytics dashboard that could not be directly mapped (e.g., by name comparison) at 430.

At 450, the pre-built analytics dashboard is executing using, at least in part, the mapped data elements in the first category. For example, the pre-built analytics dashboard can use the data elements that were directly matched between the pre-built analytics dashboard and the target landscape (e.g., those in the third category determined at 430) as well as those that were mapped using the machine learning model (e.g., the mappings to the target landscape determined at 440) when executing the pre-built analytics dashboard.

In some implementations, context information is used when performing the mapping (e.g., when performing mapping as described at 340 or 440). Context information can help determine which data element to map to within a given word pocket. For example, if a particular visualization tile of a pre-built analytics dashboard uses the “job posting owner” data element (e.g., using word pocket 110), then the context of query or business question can be considered. For example, if the query is related to displaying information about regions (e.g., related to the region word pocket 130), then the mapping to “employee” (one of the synonyms depicted at 114) may be selected.

In some implementations, the mapping prioritizes a match found within the standard terms over a match found within the synonyms. For example, if the target landscape includes a data element that matches one of the standard terms of a given word pocket as well as one of the synonyms of the given word pocket, then the match to the standard term would be mapped instead of the match to the synonym.

In some situations, there may be data elements of the pre-built analytics dashboard that do not match, and could not be mapped, to data elements in the target landscape. For example, the pre-built analytics dashboard could use data that is not maintained by the target landscape. In this situation, one or more of the elements of the pre-built analytics dashboard (e.g., one or more visualization tiles) may not display, and a warning or error message could be displayed (e.g., indicating that the target landscape does not support one or more of the dashboard elements). Similarly, there may be data elements in the target landscape that are not matched or mapped to data elements in the pre-built analytics dashboard. For example, the pre-built analytics dashboard may not use all of the data elements present in the target landscape.

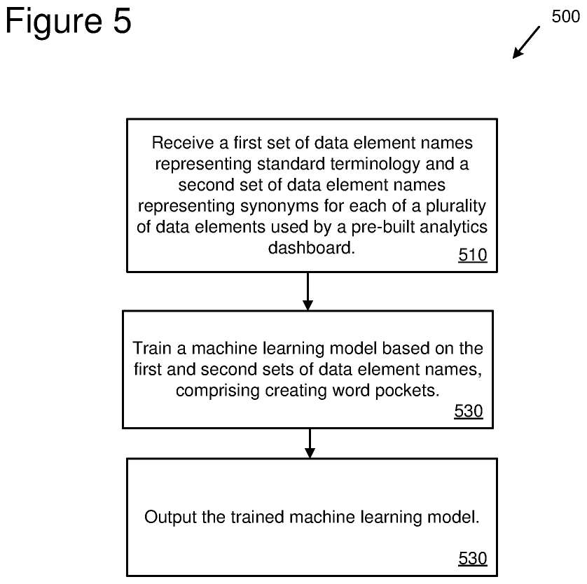

FIG. 5 is a flowchart of an example process 500 for training machine learning models for mapping data elements for pre-built analytics dashboards. For example, the example process 500 can be performed by software running on computing resources (e.g., a computing device such as a laptop, desktop, or server, or cloud computing resources).

At 510, two sets of data element names are received for each of a plurality of data elements (e.g., for each data element) used by a pre-built analytics dashboard. The first set of data element names represents standard terminology used to refer to the data element, and the second set of data element names represents synonyms used to refer to the data element.

At 520, a machine learning model is trained based, at least in part, on the first and second sets of data element names Training the machine learning model comprises generating word pockets representing the data elements used by the pre-built analytics dashboard. Specifically, a word pocket is created for each of the plurality of data elements that are used by the pre-built analytics dashboard, where each word pocket associates a data element with its corresponding set of standard terminology and its corresponding set of synonyms. In some implementations, relationships between word pockets are also created (e.g., based on context information) and represented by the trained machine learning model.

At 530, the trained machine learning model is output. For example, the trained machine learning model can be saved in association with a pre-built analytics dashboard. Later, when the pre-built analytics dashboard is to be implemented by a specific organization, mapping to the specific organization's data elements can be performed using the trained machine learning model that is associated with the pre-built analytics dashboard. Once the mapping has been performed, the pre-built analytics dashboard can be executed using the specific organization's data elements and according to the mapping.

Computing Systems

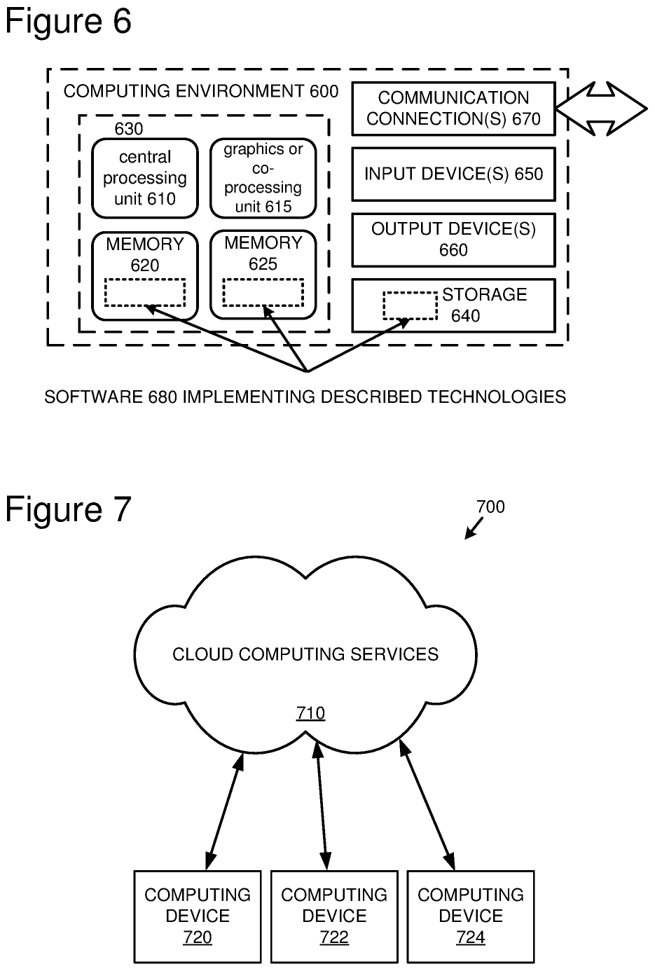

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Cloud Computing Environment

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, database resources, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed by one or more computing devices, for mapping data elements for pre-built analytics dashboards, the method comprising:
obtaining a list of data elements that are present in a target landscape;
comparing the list of data elements that are present in the target landscape to data elements used by a pre-built analytics dashboard;
based on the comparing, determining a first category of data elements that are present in the target landscape but not in the pre-built analytics dashboard, and a second category of data elements that are present in the pre-built analytics dashboard but not in the target landscape; and
for each of one or more of the data elements that are present in the pre-built analytics dashboard but not in the target landscape:
mapping the data element to one of the data elements in the target landscape using, at least in part, a trained machine learning model, wherein the trained machine learning model uses word pockets to separately associate data elements with standard terminology and synonyms.

2. The method of claim 1, wherein the machine learning model identifies a word pocket associated with the data element, wherein the word pocket is associated with a first set of standard terms and a second set of synonyms, and wherein the mapping comprises:
determining if the target landscape includes a data element that matches one of the standard terms or one of the synonyms; and
when there is a match, associating the data element in the pre-built analytics dashboard with the matching data element in the target landscape.

3. The method of claim 2, further comprising, when there is a match, the pre-built analytics dashboard uses the matching data element in the target landscape when executing the pre-built analytics dashboard.

4. The method of claim 1, wherein the mapping prioritizes a match found within the standard terminology over a match found within the synonyms.

5. The method of claim 1, wherein the machine learning model identifies a word pocket associated with the data element, wherein the word pocket is associated with a first set of standard terms and a second set of synonyms, and wherein the mapping comprises:
first, matching standard terms by:
determining if the target landscape includes a data element that matches one of the standard terms; and
when there is a match to one of the standard terms, outputting an indication of the matching standard term; and
second, when there is no match in the standard terms, matching synonyms by:
determining if the target landscape includes a data element that matches one of the synonyms; and
when there is a match to one of the synonyms, outputting an indication of the matching synonym.

6. The method of claim 1, further comprising:
executing the pre-built analytics dashboard using, at least in part, the mapped data elements in the target landscape.

7. The method of claim 1, wherein the trained machine learning model represents a plurality of word pockets, each word pocket corresponding to a different data element used by the pre-built analytics dashboard.

8. The method of claim 7, wherein the trained machine learning model further represents relationships between data elements of different word pockets.

9. The method of claim 1, wherein the data elements used by a pre-built analytics dashboard comprise one or more dimensions and/or one or more measures.

10. One or more computing devices comprising:
processors; and
memory;
the one or more computing devices configured, via computer-executable instructions, to map data elements for pre-built analytics dashboards, the operations comprising:
obtaining a list of data elements that are present in a target landscape;
comparing the list of data elements that are present in the target landscape to data elements used by a pre-built analytics dashboard;
based on the comparing, determining:
a first category of data elements that are present in the target landscape but not in the pre-built analytics dashboard;
a second category of data elements that are present in the pre-built analytics dashboard but not in the target landscape; and
a third category of data elements that match between the pre-built analytics dashboard and the target landscape;
mapping the data elements in the second category to the data elements in the first category using a trained machine learning model, wherein the trained machine learning model uses word pockets to associate data elements with standard terminology and synonyms; and
executing the pre-built analytics dashboard using, at least in part, the mapped data elements in the first category and the data elements in the third category.

11. The one or more computing devices of claim 10, wherein the third category of data elements is determined by matching data element names between the pre-built analytics dashboard and the target landscape.

12. The one or more computing devices of claim 10, wherein the mapping is performed for each of the data elements in the second category.

13. The one or more computing devices of claim 10, wherein the mapping prioritizes associations found using standard terminology over associations found using synonyms.

14. The one or more computing devices of claim 10, wherein mapping the data elements in the second category to the data elements in the first category using the trained machine learning model comprises, for each of one or more of the data elements in the second category:
applying the trained machine learning model to the data element to identify a word pocket for the data element, wherein the word pocket has a first set of standard terms and a second set of synonyms; and
identifying a match between one of the data elements in the first set of standard terms or the second set of synonyms and a data element in the first category.

15. The one or more computing devices of claim 10, wherein mapping the data elements in the second category to the data elements in the first category using the trained machine learning model comprises, for each of one or more of the date elements in the second category:
first, matching standard terms by:
determining if the first category includes a data element that matches one of the standard terms; and
when there is a match to one of the standard terms, mapping the data element to the matched standard term; and
second, when there is no match in the standard terms, matching synonyms by:
determining if the first category includes a data element that matches one of the synonyms; and
when there is a match to one of the synonyms, mapping the data element to the matching synonym.

16. The one or more computing devices of claim 10, wherein the data elements used by the pre-built analytics dashboard comprise one or more dimensions and/or one or more measures, and wherein the data elements that are present in the target landscape comprise one or more dimensions and/or one or more measures.

17. One or more computer-readable storage media storing computer-executable instructions for execution on one or more computing devices to perform operations for training machine learning models for mapping data elements for pre-built analytics dashboards, the operations comprising:
receiving, for each of a plurality of data elements that are used by a pre-built analytics dashboard:
a first set of data element names representing standard terminology used to refer to the data element; and
a second set of data element names representing synonyms used to refer to the data element;
training a machine learning model, comprising, for each of the plurality of data elements that are used by the pre-built analytics dashboard:
creating a representation of a word pocket, wherein the word pocket associates the data element with the first set of data element names representing standard terminology and the second set of data element names representing synonyms; and
outputting the trained machine learning model.

18. The one or more computer-readable storage media of claim 17, the operations further comprising:
mapping an input data element using the trained machine learning model.

19. The one or more computer-readable storage media of claim 17, the operations further comprising:
applying the trained machine learning model to map data elements that are present in the pre-built analytics dashboard to data elements of a target landscape; and
executing the pre-built analytics dashboard using, at least in part, the mapped data elements of the target landscape.

20. The one or more computer-readable storage media of claim 19, wherein the mapping prioritizes associations found using standard terminology over associations found using synonyms.
